(19) United States
(12) Patent Application Publication
(10) Pub. No.: US 2014/0126032 A1
(43) Pub. Date: May 8, 2014

(54) IMAGE DISPLAY DEVICE

(71) Applicants: Masahiko Yatsu, Ibaraki (JP); Koji Hirata, Ibaraki (JP)

(72) Inventors: Masahiko Yatsu, Ibaraki (JP); Koji Hirata, Ibaraki (JP)

(21) Appl. No.: 14/124,779

(22) PCT Filed: Jun. 10, 2011
(86) PCT No.: PCT/JP2011/003284

§ 371 Date: Dec. 9, 2013

(51) Int. Cl. G02B 26/10

(52) U.S. Cl. CPC G02B 26/10
USPC 359/201.2

(57) ABSTRACT

An image display device having a scanning characteristic excellent in the linearity without being upsized is provided.

The image display device includes: an optical scanning unit that scans a light emitted from a light source in a first direction and a second direction of an image plane due to a rotational movement of reciprocation of a reflecting surface of the light; and an optical system enlarges a scanning angle of the scanned light, in which the optical system has a free-form-surface lens on an optical scanning unit side, and has a free-form-surface mirror on an image plane side. The free-form-surface mirror may be arranged so that the first direction is substantially parallel to a first plane defined by an incident optical beam and a reflected light in the free-form-surface mirror when the optical scanning unit remains static in the center of the scanning area.

### TECHNICAL FIELD

The present invention relates to an image display device.

### BACKGROUND ART

In recent years, there has been proposed image display devices having an optical scanning device that scans a laser beam subjected to optical intensity modulation (hereinafter, modulation) according to an image signal in a two-dimensional direction, and scans an image plane (for example, screen) with the laser beam by the optical scanning device to draw an image (refer to Patent Literatures 1 and 2).

### CITATION LIST

### Patent Literature

Patent Literature 1: Japanese Unexamined Patent Application Publication No. 2010-139687

Patent Literature 2: Japanese Unexamined Patent Application Publication No. 2006-178346

### SUMMARY OF INVENTION

### Technical Problem

According to Patent Literature 1, there arises such a problem that a movement locus of scanning coordinates on the image plane becomes sinusoid, and its linearity is low. Also, according to Patent Literature 2, there arises such a problem that a mirror interval needs to be increased to upsize an overall optical system.

Under the circumstances, an object of the present invention is to provide an image display device having a scanning characteristic excellent in the linearity without being upsized.

### Solution to Problem

In order to solve the above problem, one of desirable modes of the present invention is described below.

The image display device includes: an optical scanning unit that scans a light emitted from a light source in a first direction and a second direction of an image plane due to a rotational movement of reciprocation of a reflecting surface of the light; and an optical system enlarges a scanning angle of the scanned light, in which the optical system has a free-form-surface lens on an optical scanning unit side, and has a free-form-surface mirror on an image plane side.

### Advantageous Effects of Invention

According to the present invention, there can be provided an image display device having a scanning characteristic excellent in the linearity without being upsized.

### BRIEF DESCRIPTION OF DRAWINGS

FIG. 1 is a system diagram illustrating an image display device.

FIG. 2 is a top view illustrating the system of FIG. 1.

FIG. 3 is a diagram of one optical beam in the first embodiment.

FIG. 4 is a diagram of another optical beam in the first embodiment.

FIG. 5 is a diagram illustrating the detail of a free-form-surface lens according to the first embodiment;

FIG. 6 is a diagram of a three-dimensional optical beam in the first embodiment.

FIG. 7 is a diagram illustrating lens data according to the first embodiment.

FIG. 8 is a diagram illustrating a mathematical expression of a free curved surface coefficient, and specific values according to the first embodiment.

FIG. 9 is a diagram illustrating a distortion performance according to the first embodiment.

FIG. 10 is a diagram illustrating a relationship between an incident angle and a phase of the optical beam on the image plane according to the first embodiment.

FIG. 11 is a diagram illustrating a relationship between an incident angle and a phase of the optical beam on the image plane according to the first embodiment.

FIG. 12 is a diagram illustrating an area of the optical beam in which coordinates of a main optical beam are present.

FIG. 13 is a diagram of an optical beam in a cross-section in a long side direction.

FIG. 14 is a diagram illustrating shapes of a free-form-surface lens and a mirror in a short side direction.

FIG. 15 is a diagram of one optical beam according to a second embodiment.

FIG. 16 is a diagram of another optical beam according to the second embodiment.

FIG. 17 is a diagram illustrating the detail of a free-form-surface lens according to the second embodiment;

FIG. 18 is a diagram illustrating lens data according to the second embodiment.

FIG. 19 is a diagram illustrating specific values of a free curved surface coefficient according to the second embodiment.

FIG. 20 is a diagram illustrating a distortion performance according to the second embodiment.

FIG. 21 is a diagram of one optical beam according to a third embodiment.

FIG. 22 is a diagram of another optical beam according to the third embodiment.

FIG. 23 is a diagram illustrating the detail of a free-form-surface lens according to the third embodiment.

FIG. 24 is a diagram illustrating lens data according to the third embodiment.

FIG. 25 is a diagram illustrating specific values of a free curved surface coefficient according to the third embodiment.

FIG. 26 is a diagram illustrating a distortion performance according to the third embodiment.

FIG. 27 is a system diagram illustrating a conventional image display device.

FIG. 28 is an enlarged diagram of an optical scanning unit.

FIG. 29 is a diagram of a relationship between a rotation angle and a scanning position in a conventional art.

FIG. 30 is a diagram of a change in an oscillation angle by a phase in the conventional art.

FIG. 31 is a diagram illustrating a relationship between an incident angle and a phase of the optical beam on the image plane in the conventional art.

FIG. 32 is a diagram illustrating a relationship between incident coordinates and a phase of the optical beam on the image plane in the conventional art.

### DESCRIPTION OF EMBODIMENTS

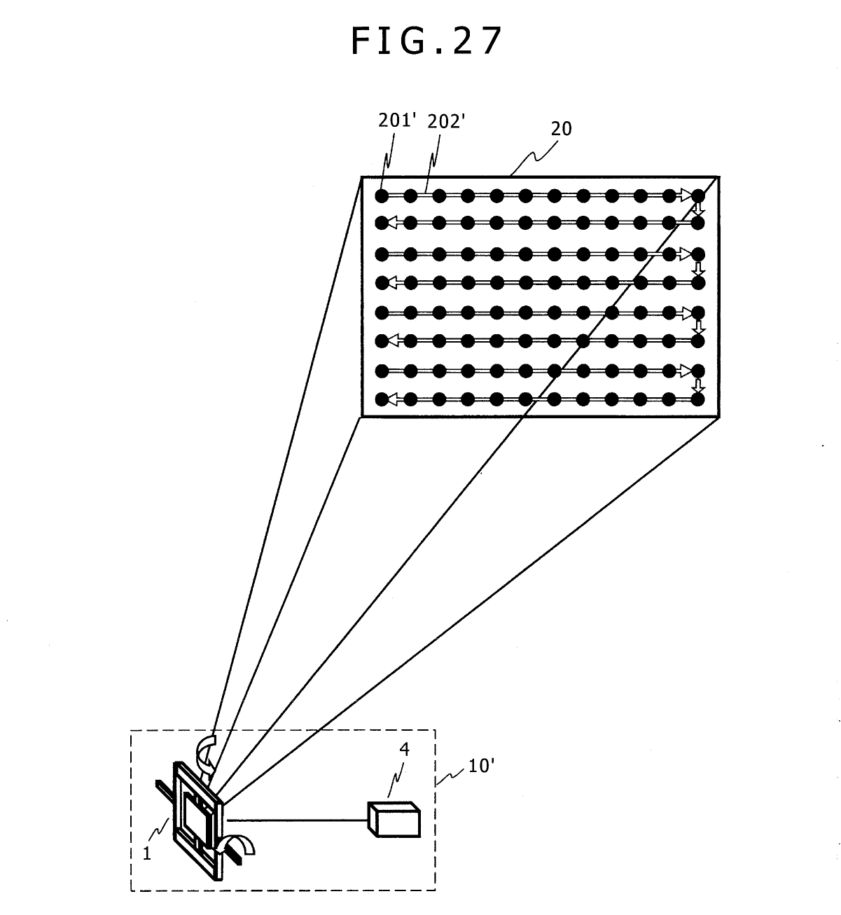

Hereinafter, for comparison with this embodiment, a conventional art will be first described. FIG. 27 is a system diagram illustrating a conventional image display device.

An optical scanning unit 1 in an image display device 10′ scans an image plane (screen) 20 with a laser beam from a light while being 4 being reflected by a reflective mirror having a rotating shaft. Respective pixels 201′ are two-dimensionally scanned along a scanning locus 202′.

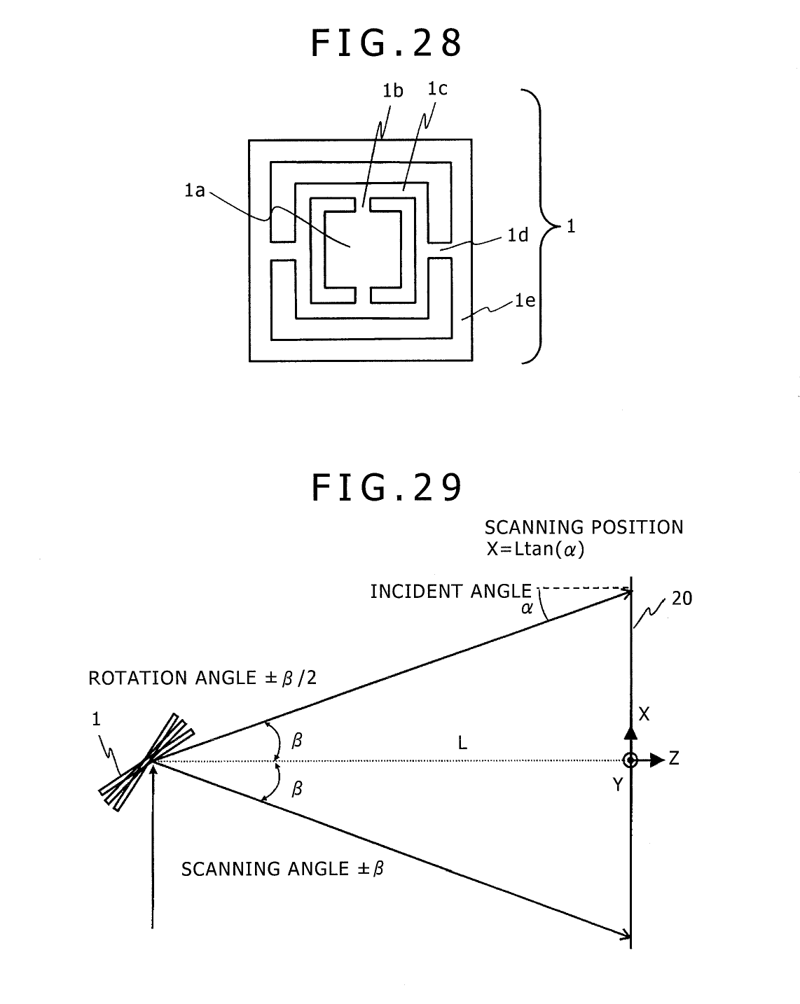

FIG. 28 is an enlarged diagram of the optical scanning unit.

The optical scanning unit 1 includes a mirror 1a that deflects the laser beam at a reflection angle, a first torsion spring 1b coupled to the mirror 1a, a retention member 1c coupled to the first torsion spring 1b, a second torsion spring 1d coupled to the retention member 1c, and a permanent magnet and a coil not shown.

The coil is formed substantially in parallel to the mirror 1a, and when the mirror 1a is in a static state, a magnetic field substantially parallel to the mirror 1a is generated. When a current flows in the coil, a Lorentz force substantially perpendicular to the mirror 1a is generated according to the Fleming's left-hand rule.

The mirror 1a is rotated to a position at which the Lorentz force matches with a restorative force of the torsion springs 1b and 1d. An AC current is supplied to the coil at a resonance frequency of the mirror 1a whereby the mirror 1a conducts resonant operation, and the first torsion spring 1b rotates. Also, the AC current is supplied to the coil at the resonance frequency combining the mirror 1a and the retention member 1c, whereby the mirror 1a, the torsion spring 1b, and the retention member 1c conduct the resonant operation, and the torsion spring 1d rotates. In this way, the resonant operation caused by different resonance frequencies is realized in the two directions.

Instead of the resonant operation using the resonance frequency, not the resonant operation but sinusoidal drive may be applied.

FIG. 29 is a relationship diagram of a rotation angle and a scanning position in a conventional art. If it is assumed that the rotation angle of the optical scanning unit 1 is β/2, a scanning angle which is an angle of the reflected optical beam is β. In this example, if no optical element is arranged between the optical scanning unit 1 and an image plane 20, the scanning angle β is equal to an incident angle α on the image plane 20. Therefore, a size of the scanned image to a certain projector distance is determined according to the rotation angle β/2.

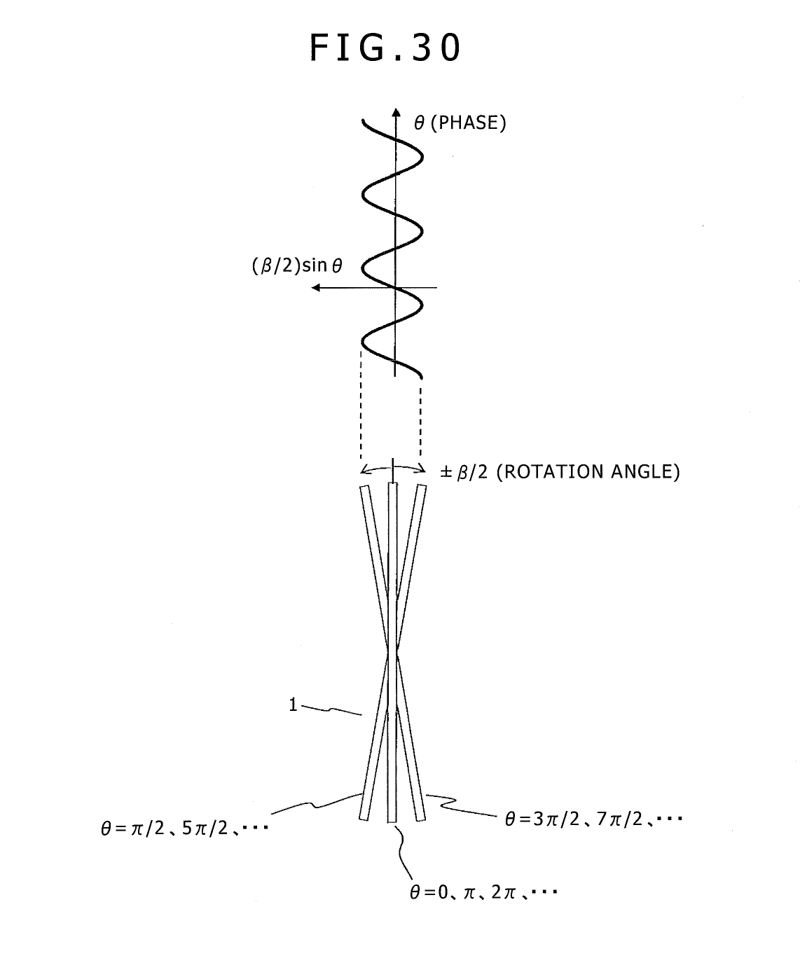

FIG. 30 is a diagram of a change in an oscillation angle of a mirror surface in the conventional art. An oscillation angle θ is changed into a sinusoidal wave within a range of ±β/2.

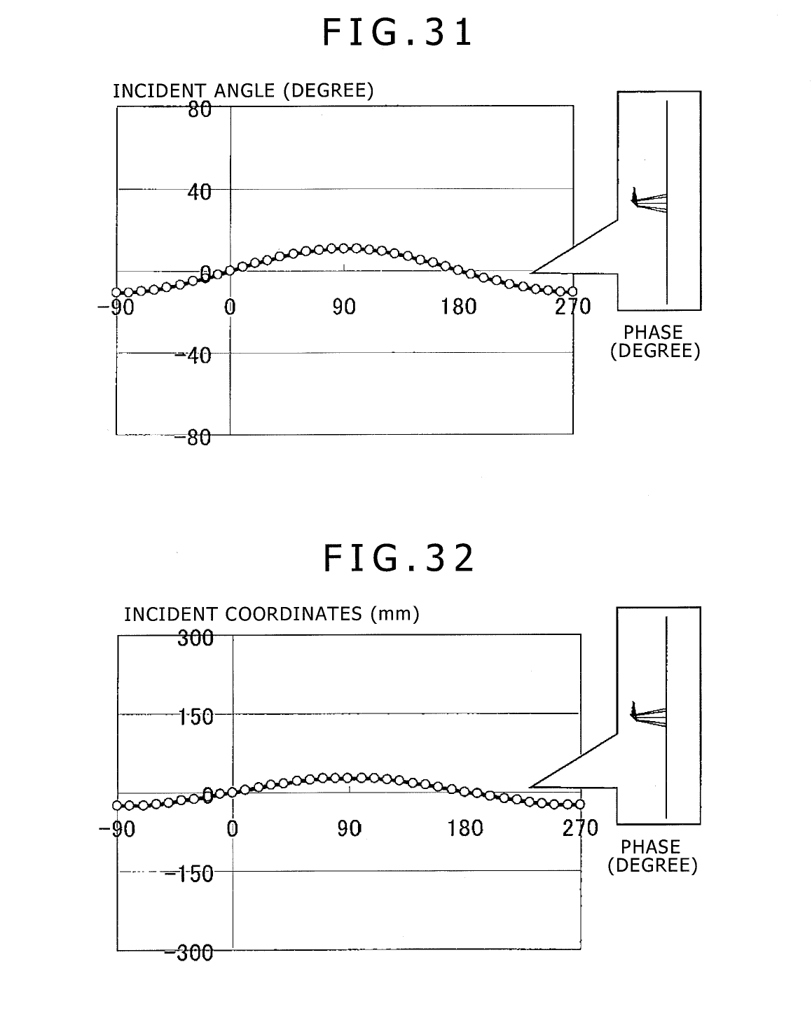

FIG. 31 is a diagram illustrating a relationship between the incident angle and a phase of the optical beam on the image plane in the conventional art. FIG. 32 is a diagram illustrating a relationship between incident coordinates and the phase of the optical beam on the image plane in the conventional art. FIG. 32 shows the state of a sine wave similar to that in FIG. 31.

Those figures show an example using the optical scanning unit 1 with the rotation angle of ±5.3 degrees. That is, the scanning angle β becomes ±10.6 degrees, and the incident angle α on the image plane also becomes ±10.6 degrees.

As the drive system of the optical scanning unit 1, there is a galvanometer mirror producing a rotation angle change of a saw-tooth wave shape except for a resonant mirror producing a rotation angle change of a sinusoidal wave. The resonant mirror large in drive frequency is proper for high-resolution image display.

In this example, in two-dimensional scanning corresponding to scanning lines of a television, scanning is conducted in a horizontal direction by the number of pixels in a vertical direction while scanning for one reciprocation is being conducted in the vertical direction. In this way, scanning for one scanning line is conducted. For example, in order to conduct a display of 800 pixels in the horizontal direction and 600 pixels in the vertical direction at a vertical frequency 60 Hz, 300 reciprocations are necessary, and driving at a high-speed frequency of 60×300=18000 Hz is required. On the other hand, driving at higher frequency is required as display resolution (the number of pixels) is more increased. On the other hand, in order to realize a large scanned image at a given projector distance, there is a need to increase the rotation angle of the optical scanning unit 1.

If the optical scanning unit 1 is driven at a larger rotation angle at a higher speed, a load of the torsion springs 1b and 1d of a mechanism part which is a movable portion is increased. Therefore, in the resonant mirror, it is difficult to realize the higher-speed frequency and the larger rotation angle at the same time.

Also, in the sinusoidal rotation of the optical scanning unit 1, fast and slow angle changes of the mirror 1a cyclically appear. When the image plane 20 is scanned with the laser beam by only the rotation, if the angle change of the mirror is fast, a change in the scanning position on the image plane is also fast, and if the angle change of the mirror is slow, a change in the scanning position on the image plane is also slow. Therefore, on the image plane, light and dark corresponding to the sinusoidal wave are generated on the image plane.

Likewise, when the laser beam is modulated at regular time intervals, pixels on the image plane are coarsely arranged if the angle change of the mirror 1a is fast, and pixels on the image plane are densely arranged if the angle change of the mirror 1a is slow, thereby resulting in a two-dimensional image having a linearity largely degraded.

If circuit processing that thins the laser beam in portions where a pixel distribution is dense, and the sinusoidal wave shape is light, only the light and dark on the image plane can be improved, but the linearity of the two-dimensional image cannot be improved. As a result, a circuit scale is increased, and the amount of light is reduced. The linearity can be improved if the laser beam is modulated at timing of arrangement of the pixels on the image plane, but the circuit scale is more and more increased.

Under the circumstances, a technique using a plurality of reflecting surfaces apart from the mirror is also considered. However, when a shape error and the eccentricity/inclination of optical components in manufacture occur, a fluctuation of the optical beam angle on the mirror is twice as large as that on the lens surface which is a transmission surface. This makes it difficult to manufacture the optical system making great use of the mirrors. Further, in the optical system using a plurality of mirrors, in order to ensure the optical path before and after reflection of the laser beam by the mirrors, large intervals need to be provided before and after the mirrors. As a result, the overall optical system is upsized.

### First Embodiment

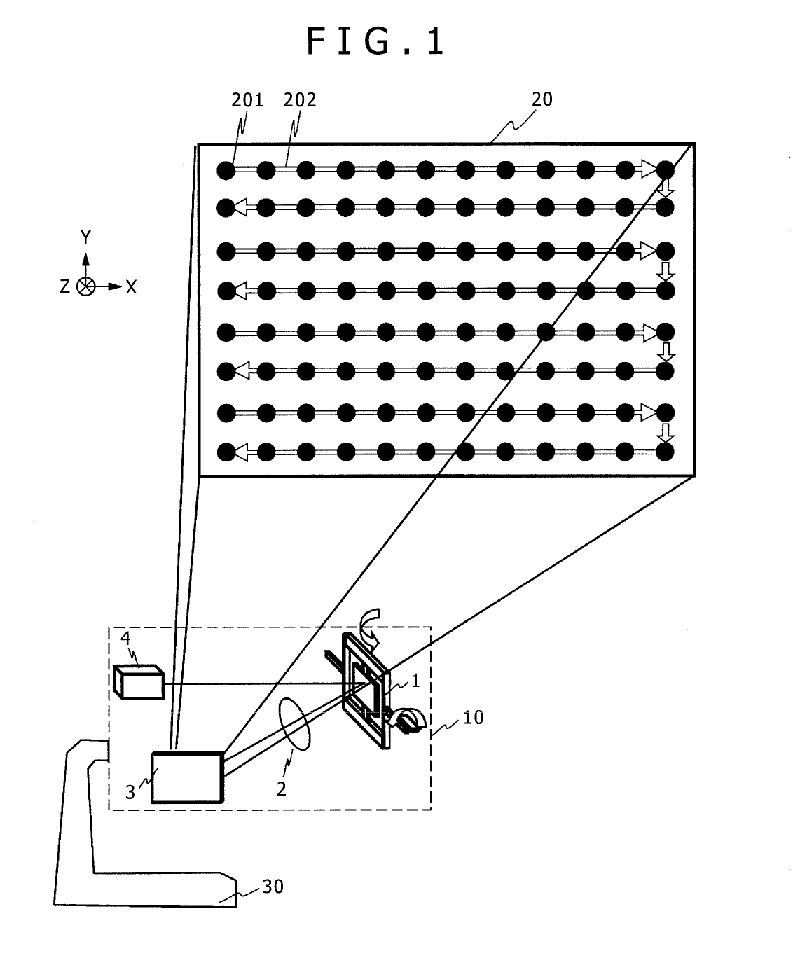

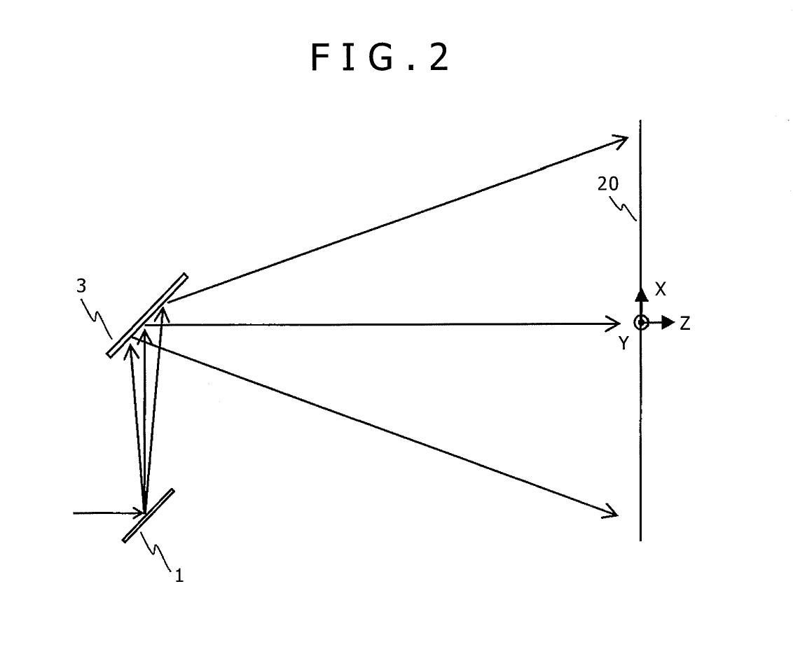

Subsequently, embodiments will be described. A first embodiment will be described with reference to FIGS. 1 to 14. FIG. 1 is a system diagram illustrating an image display device. In this drawing, a direction from left to right on a paper plane is defined as an X-direction, a direction from bottom to top on the image plane 20 is defined as a Y-direction, and a direction from front to back on the paper plane is defined as a Z-direction. FIGS. 2, 27, and 29 also use the same coordinate system as that of FIG. 1. Drawings other the above drawings use a local coordinate system having an optical axis as the Z-direction.

The system includes an image display device 10, a structure 30 that holds the image display device 10, and the image plane 20. Also, the image display device 10 includes a light source 4, the optical scanning unit 1 that two-dimensionally deflects a laser beam from the light source 4, a free-form-surface lens 2 that transmits and refracts the optical beam deflected by the optical scanning unit 1, and a free-form-surface mirror 3 that reflects the optical beam from the free-form-surface lens 2, and guides the optical beam to the image plane 20. Those optical components are subjected to an improvement in the linearity, and the action of wider angle (which will be described later), and a two-dimensionally scanned image which is rectangular and uniform in light quantity distribution is displayed on the image plane 20.

The optical scanning unit 1 may realize the scanning in a long side direction and a short side direction by one reflecting surface (mirror 1a), or may have the respective reflecting surfaces in correspondence with the respective directions.

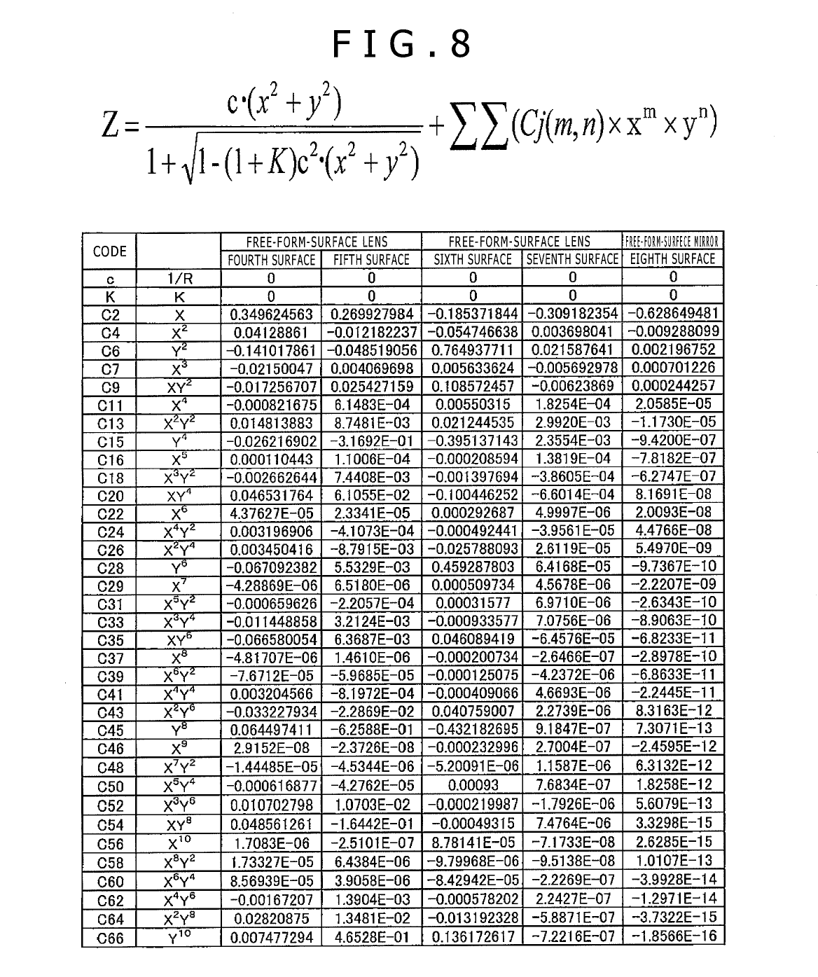

In this example, a shape having a rotational asymmetry and parameters illustrated in FIGS. 8, 19, and 25 is called “free curved surface”.

FIG. 2 is a top view illustrating the system of FIG. 1.

Hereinafter, because a side corresponding to the X-direction is longer than a side corresponding to the Y-direction in the image plane 20, the former is called “long side”, and the latter is called “short side”. Also, a direction larger in the deflection angle on the reflecting surface corresponds to the long side direction, and the smaller direction corresponds to the short side direction.

When the optical scanning unit 1 remains static in the center of a scanning area, the free-form-surface mirror 3 is arranged so that a long side thereof becomes substantially in parallel to a first plane (XZ plane) defined by an incident optical beam and a reflected optical beam in the free-form-surface mirror 3. The reason is because when the free-form-surface mirror 3 is arranged obliquely to the optical beam of the long side larger in the amount of scanning, a coordinate range in which the optical beam scanned at a scan angle which is twice as large as a given rotation angle is reflected by the free-form-surface mirror 3 becomes widened, and therefore a shape freedom of the free-form-surface mirror 3 is increased.

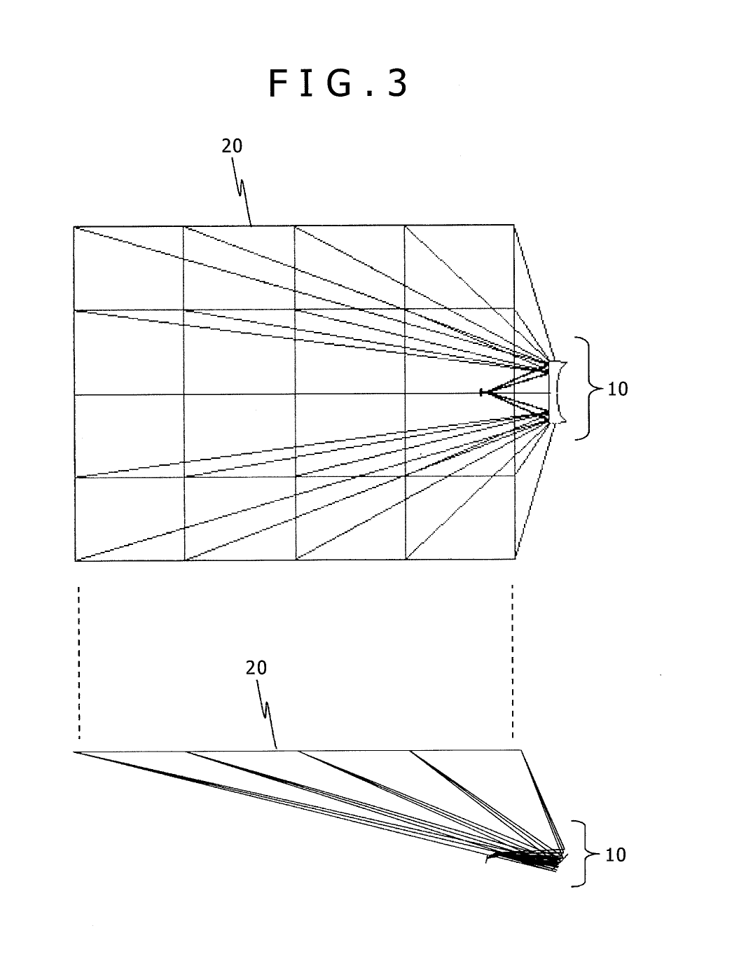

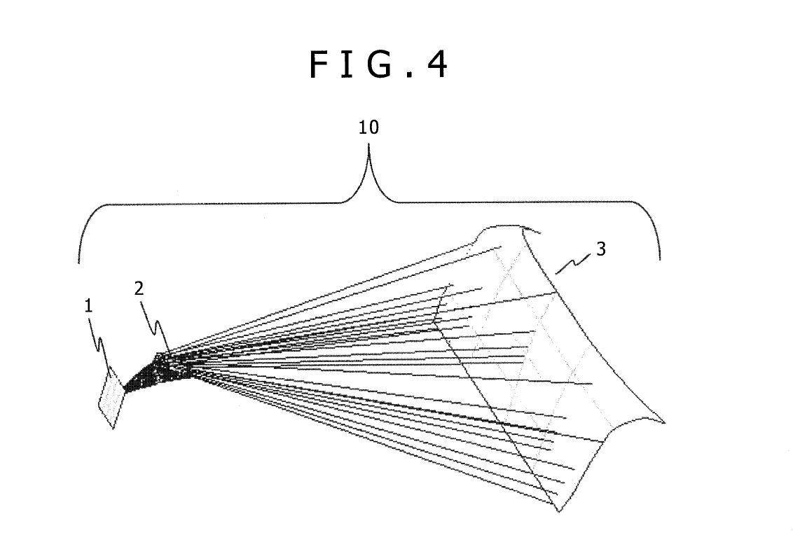

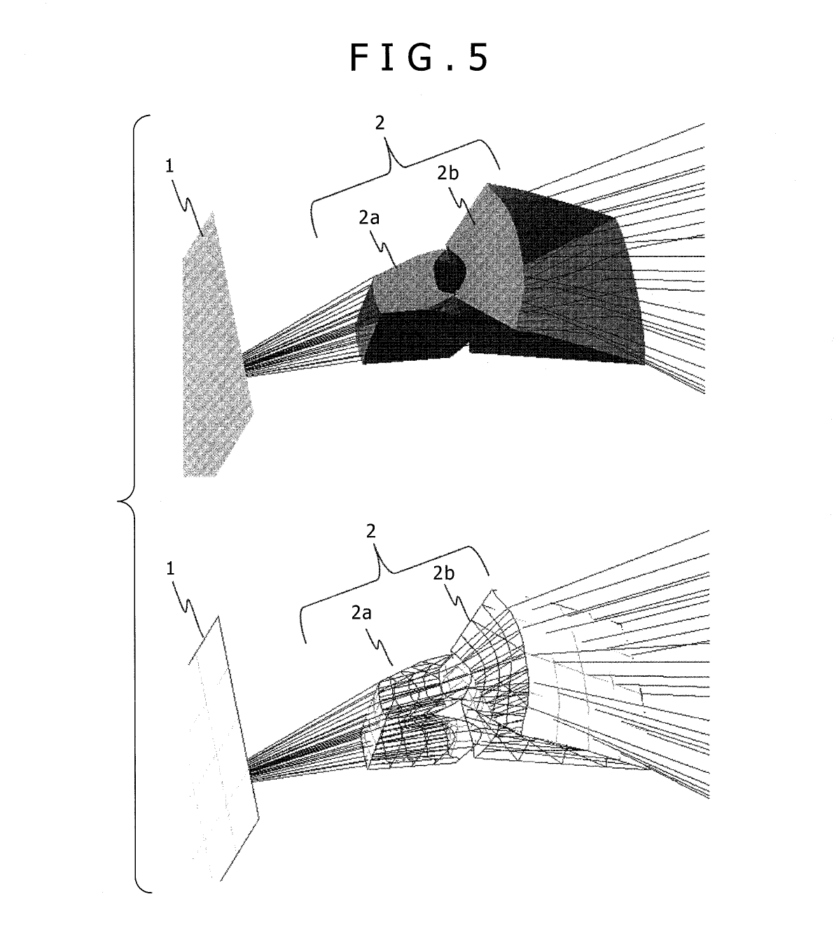

FIG. 3 is one diagram of the optical beam in which the optical beam emitted from the image display device 10 arrives at 5×5 division points on the image plane 20. FIG. 4 is another diagram of the optical beam in which after the optical beam emitted from the light source 4 is deflected by the rotation of the optical scanning unit 1, the optical beam arrives at the image plane 20 through the free-form-surface lens 2 and the free-form-surface mirror 3. Further, FIG. 5 is a diagram of the detail of the free-form-surface lens 2, which is configured by a first free-form-surface lens 2a and a second free-form-surface lens 2b.

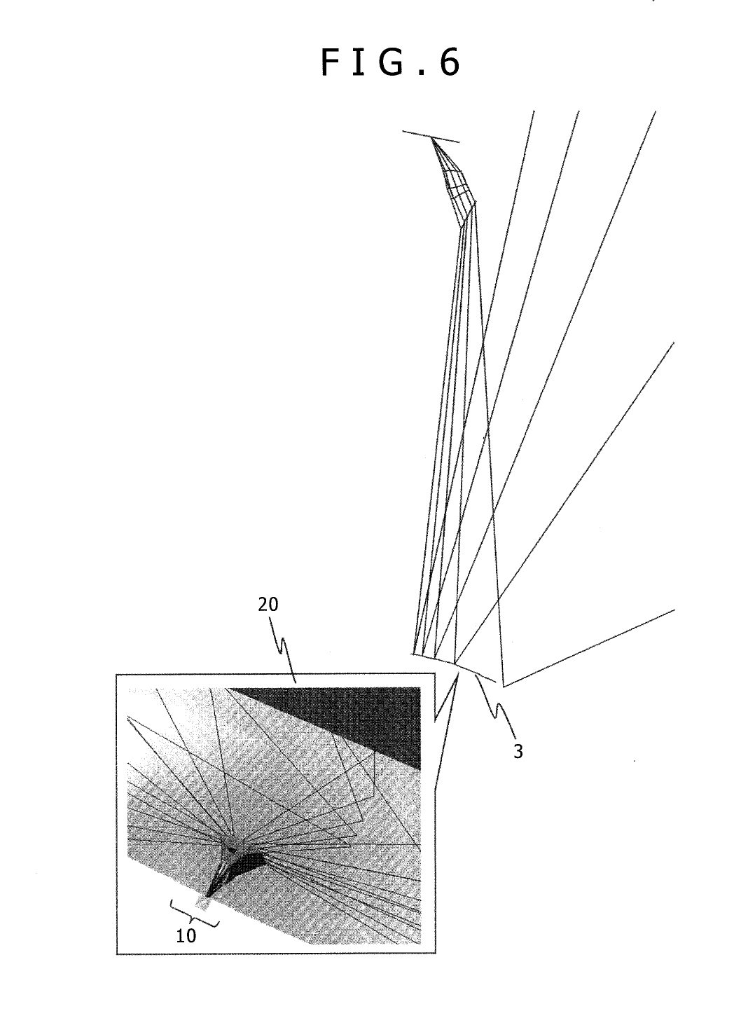

FIG. 6 is a diagram of the three-dimensional optical beam. In FIG. 3, a phenomenon in which the free-form-surface lens 2 is not irradiated with the optical beam reflected by the free-form-surface mirror 3 is difficult to understand. Therefore, in FIG. 6, it is understood that no optical paths interfere with each other.

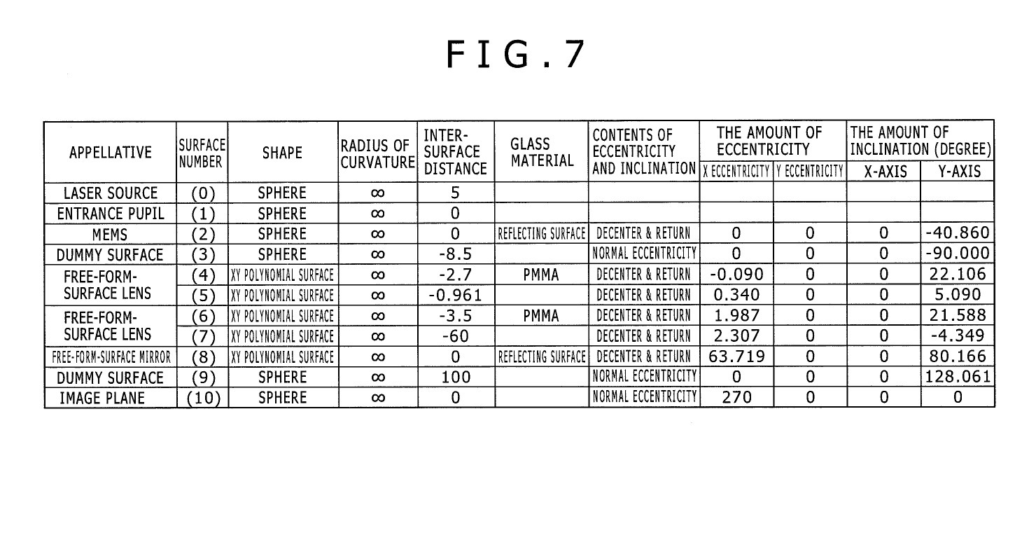

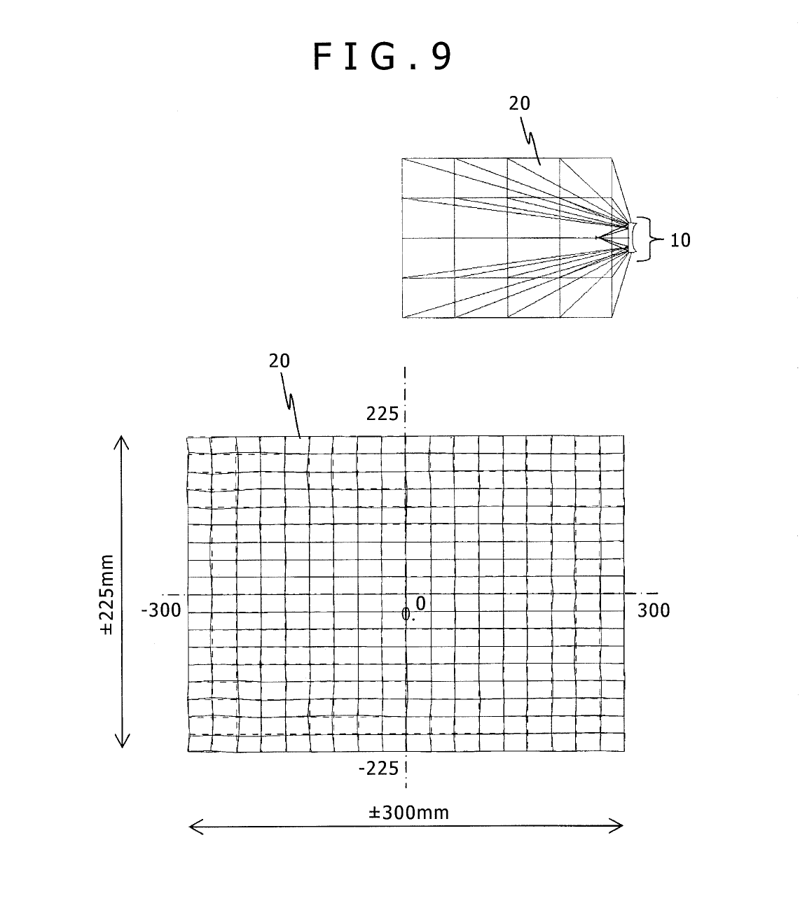

FIG. 7 is a diagram illustrating lens data of an MEMS (micro electro mechanical systems) mirror (resonance rotation ±5.3 degrees horizontally and ±2.9 degrees vertically), the free-form-surface lens, and the free curved mirror as the optical scanning unit 1 from the light source 4 which is a 0-th surface. FIG. 8 is a diagram illustrating a mathematical expression of the free curved surface coefficient of the free curved surface configuration, and specific values. FIG. 9 is a diagram illustrating a distortion performance according to the first embodiment. FIG. 9 is a diagram of a distortion performance. Those figures illustrate coordinates at which the optical beam having the scan angle by the optical scanning unit 1 of the rotation angle ±5.3 degrees in the long side direction (main scanning direction) and the rotation angle ±2.9 degrees in the short side direction (sub-scanning direction) arrives at the image plane 20 at every 10 degrees of a phase, and results obtained by evaluating the scanning range by division of 19×19 in detail.

Because the projector distance from the free-form-surface mirror 3 illustrated in FIG. 7 is 100 mm, and the scanning range is 600×450 mm on the image plane 20, an appearance in which the wider angle is realized is understood.

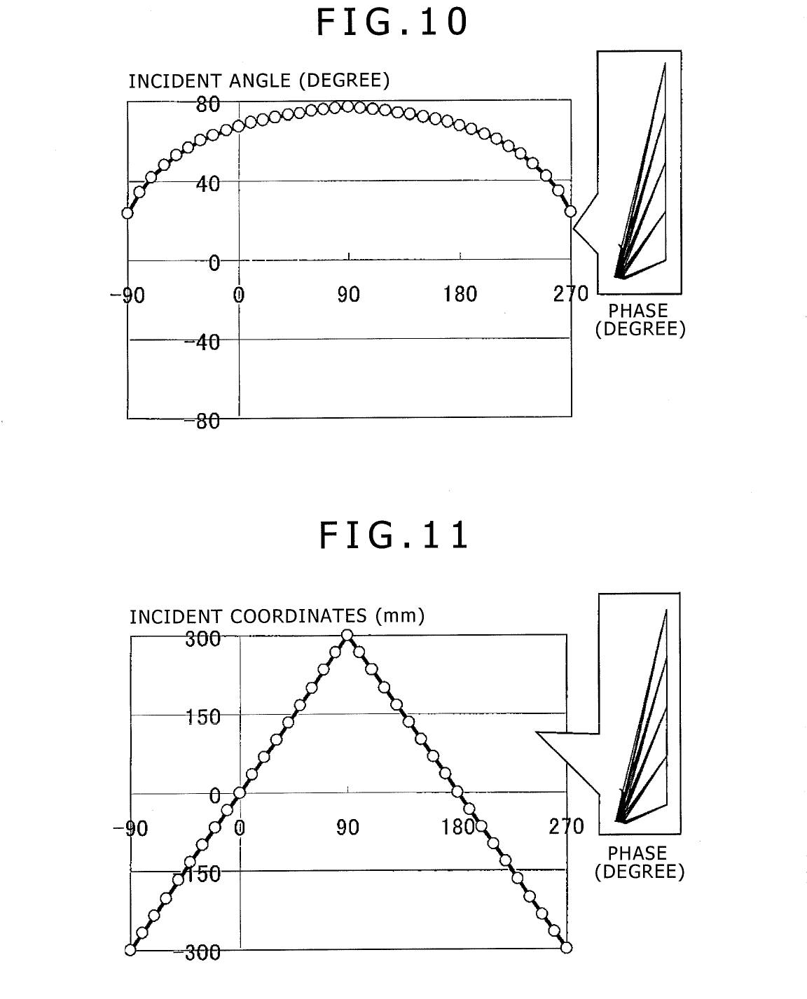

Subsequently, an improvement in the linearity and the results of the wider angle will be described on the basis of the incident angle and the incident coordinates on the image plane with reference to FIGS. 10 to 14, 31, and 32.

In FIGS. 31 and 32 illustrating a conventional example, none of the free-form-surface lens 2 and the free-form-surface mirror 3 is present. The incident angle is changed into a sinusoidal wave shape in a range of ±10.6 degrees which is a value twice as large as 5.3 degrees, and the incident coordinates are also changed into a sinusoidal wave shape in a range of ±26.6 mm.

On the other hand, in the first embodiment, FIG. 10 is a diagram illustrating a relationship between the incident angle and the phase of the optical beam on the image plane, and FIG. 11 is a diagram illustrating a relationship between the incident angle and the phase of the optical beam on the image plane according to the first embodiment. The incident angle is largely changed by the action of the free-form-surface lens 2 and the free-form-surface mirror 3 to realize the incident coordinates of a chopping wave shape on the image plane 20 in a range of ±300 mm. That is, the scanning range is ±26.6 mm in the conventional system whereas the scanning range is ±300 mm in the first embodiment to realize a remarkably wider angle of 10 times or more. Also, when it is assumed that a horizontal size corresponding to the long side is X, and the projector distance is L, since X=600 mm and L=100 mm are satisfied, to thereby realize L/X which is a small value, that is, 0.17.

The projector distance is defined by a length of a vertical line which lowers from a reference position defining an arrangement position of the free-form-surface mirror on lens data toward the image plane. In an intended purpose giving priority to the downsizing of the image display device, a value of L/X may be increased without exceeding 1.

For comparison, in the above Patent Literature 1, if a value of L/X is calculated on the disclosure that the shape is symmetric in a horizontal direction, and the angle of view is ±18.9 degrees, a large value such as L/X=½/tan18.9=1.46 is obtained, and the wider angle is insufficient.

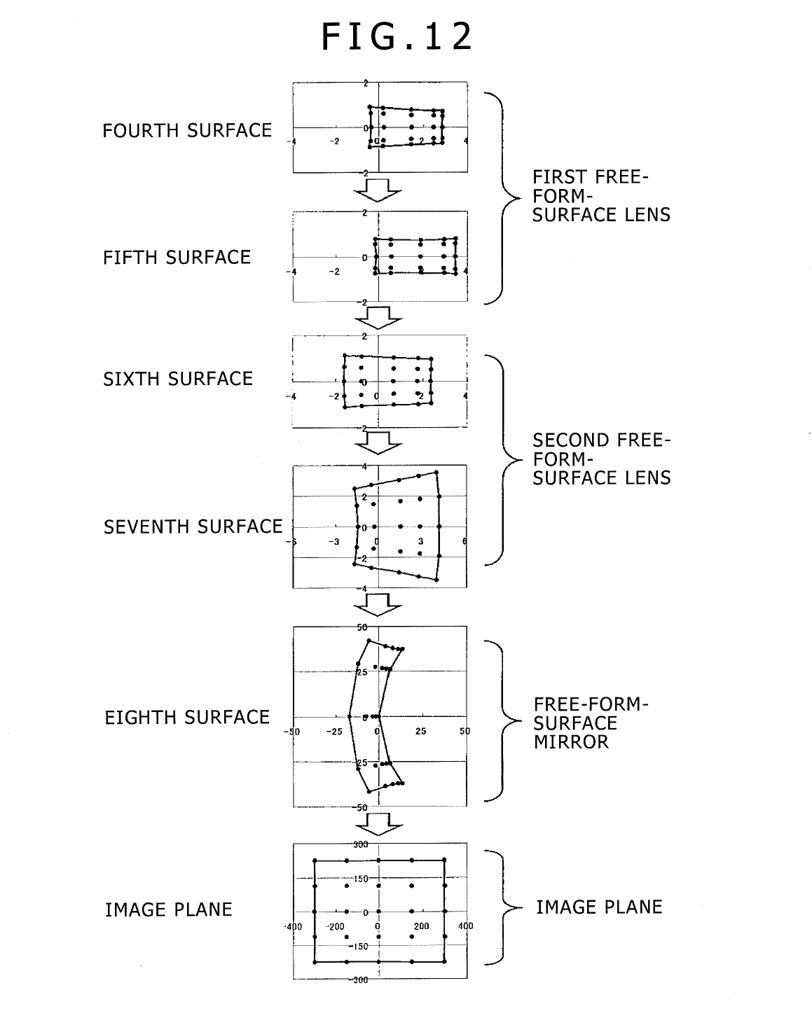

Subsequently, the features of the free-form-surface lens 2 and the free-form-surface mirror 3 will be described with reference to FIGS. 12 to 14.

FIG. 12 illustrates a range of the optical beam where the coordinates of a main optical beam is present as the control results of the optical beam by the free-form-surface lens 2 and the free-form-surface mirror 3. Since the long side direction of the optical scanning unit 1 is larger than the short side direction thereof, a range of the main optical beam on a fourth surface which is the incident surface of the first free-form-surface lens 2a is a horizontal long area.

It is found that the range of the main optical beam is changed into the horizontal long area every time the main optical beam sequentially passes through an output surface of the first free-form-surface lens 2a and the second free-form-surface lens 2b.

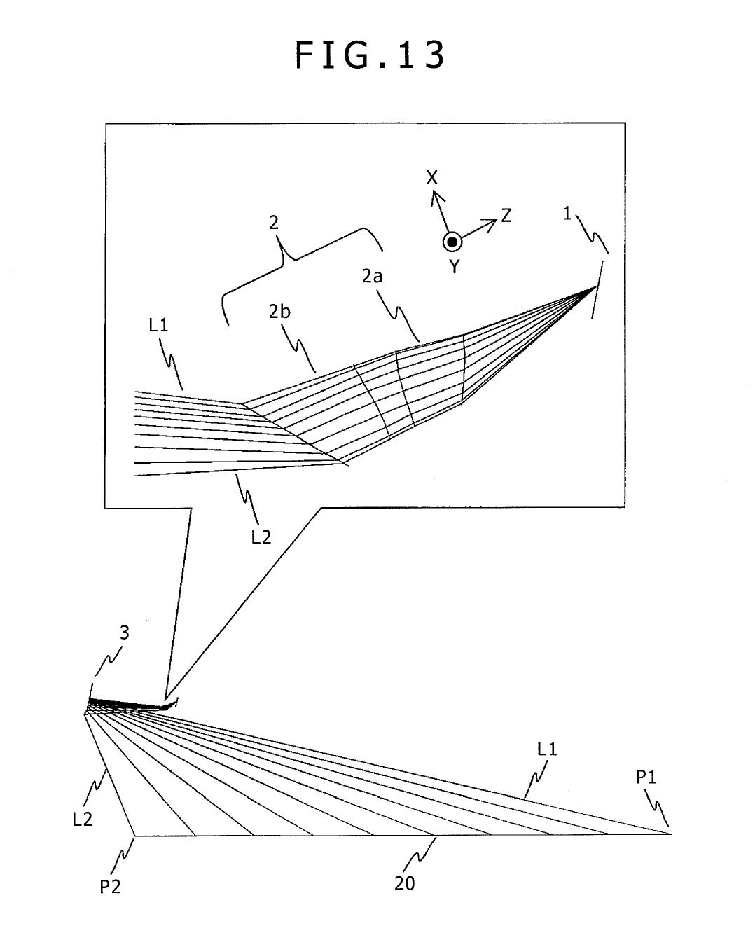

The horizontal long area is formed in an eighth surface which is the free-form-surface mirror 3, but the long side direction (lateral direction of FIG. 12) is not extremely narrowed in the eighth surface, but a vertical size in the eighth surface is increased as the degree of freedom. The reason will be described with reference to FIG. 13.

FIG. 13 is a diagram of an optical beam in a cross-section in the long side direction, which is a diagram illustrating an optical beam diagram of the overall optical system and an enlarged diagram of the free-form-surface lens 2 together. With the rotation of the optical scanning unit 1, an optical beam L1 that passes through a positive side of the X-axis in FIG. 13 is reflected by the free-form-surface mirror 3, and arrives at coordinates P1 on the image plane 20. On the other hand, an optical beam L2 that passes through a negative side of the X-axis is reflected by the free-form-surface mirror 3, and arrives at coordinates P2 on the image plane 20. In this example, it is necessary that the optical paths along which the optical beam L2 that passes through the second free-form-surface lens 2b and the optical beam L1 that is reflected by the free-form-surface mirror do not interfere with each other on the second free-form-surface lens 2b. In order to achieve this configuration, it is necessary that a width formed by the optical beam L1 and the optical beam L2 on the free-form-surface mirror 3 is small. This is a reason that the size of an optical beam passage range in the horizontal direction in the free-form-surface mirror 3 is small.

Also, in FIG. 13, an optical path length of the optical beam L1 from the reflection on the free-form-surface mirror 3 to the image plane is larger than the optical path length of the optical beam L2. Therefore, in order to improve the linearity, it is necessary that the optical path length of the optical beam L1 is made shorter than the optical path length of the optical beam L2 in the free-form-surface lens 2 and the free-form-surface mirror 3.

Under the circumstances, thickening the lens thickness on a side through which the optical beam L1 passes, that is, “artificial prism” is necessary for making the optical path length of the optical beam L1 that passes through the free-form-surface lens 2 in air conversion smaller than a value of the optical beam L2.

In the optical system of this embodiment, it is desirable to reduce a difference of the optical path length in the overall optical pat by satisfying L1<L2 on an object side with respect to L1>L2 on an enlarged side by not a mapping relationship but conceptually wide conversion.

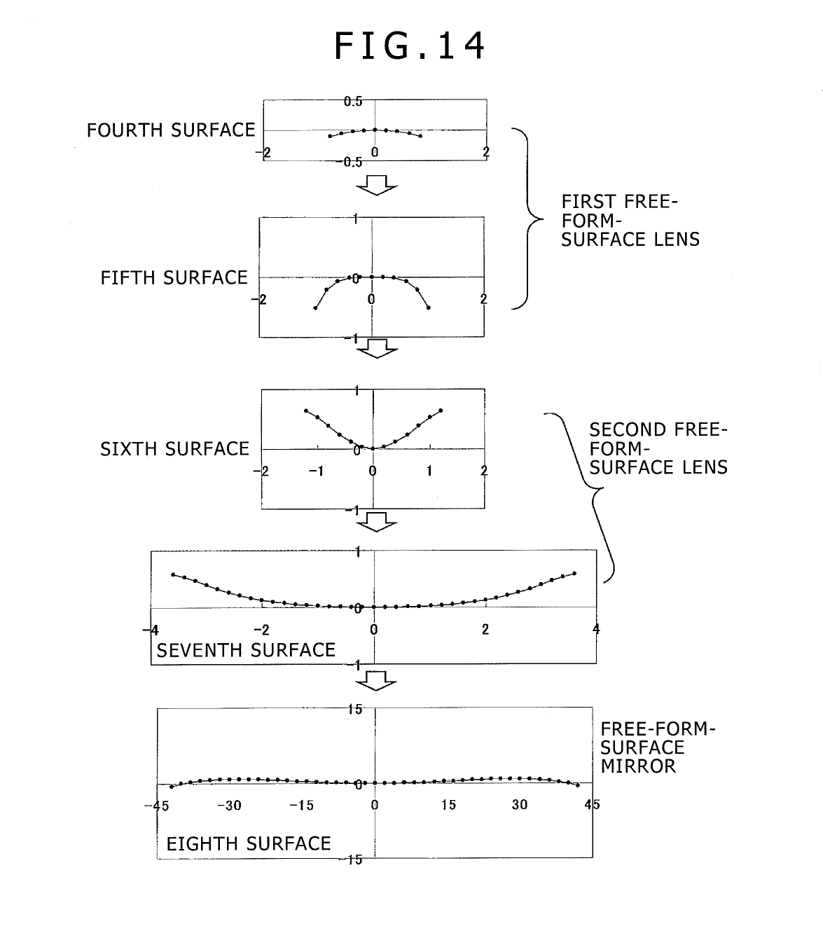

Subsequently, the features in the short side direction will be described with reference to FIG. 14 which is a diagram of sag quantities of the respective optical elements in the short side direction. FIG. 14 is a diagram illustrating the shapes of the free-form-surface lens and mirror in the short side direction.

Referring to FIG. 14, the first free-form-surface lens 2a and the second free-form-surface lens 2b in the short side direction each have a negative refractive power in a concave lens shape. The free-form-surface mirror 3 has a positive refractive power in a center portion of a concave surface, and a negative refractive power in a peripheral portion of a convex surface. Because of the above configuration, the lens data in the first embodiment is arranged plane-symmetrically in the short side direction. However, the condition of the plane symmetry, that is, the arrangement relationship is changed to change a portion of a positive refractive power and a portion of a negative refractive power. Therefore, the portion of the positive refractive power and the portion of the negative refractive power are present in the free-form-surface mirror 3.

As described above, when the free-form-surface lens 2 and the free-form-surface mirror 3 are arranged under a given condition, there is no need to increase the rotation angle of the MEMS mirror as the optical scanning unit 1, and the wider angle of 10 times or more and an improvement in the linearity can be realized without damaging the mechanical reliability of the MEMS mirror.

### Second Embodiment

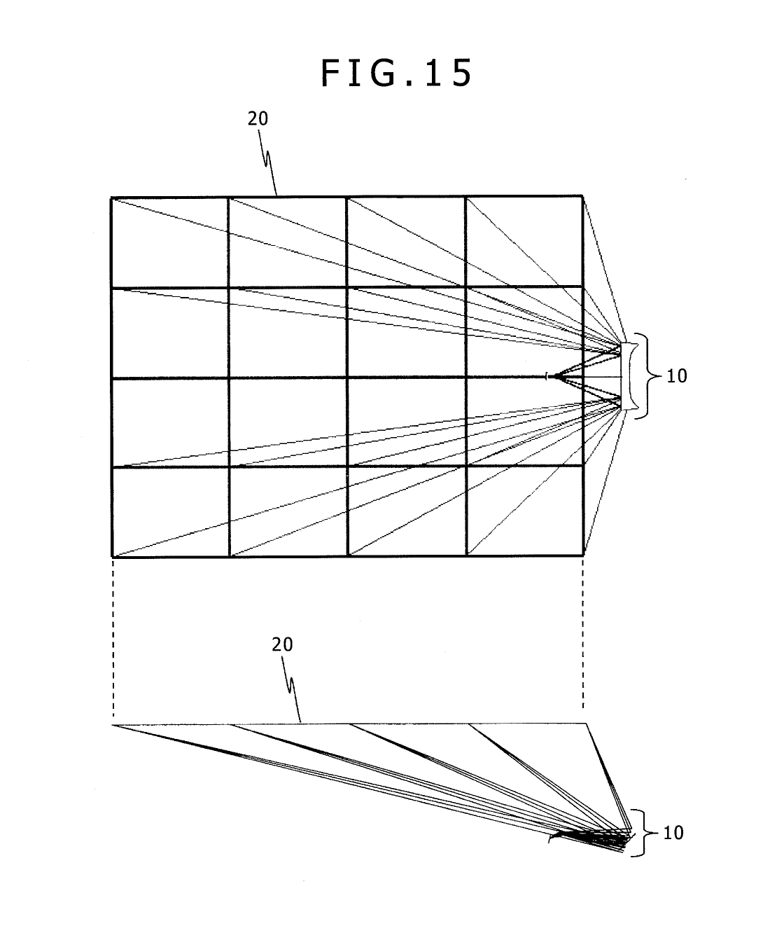

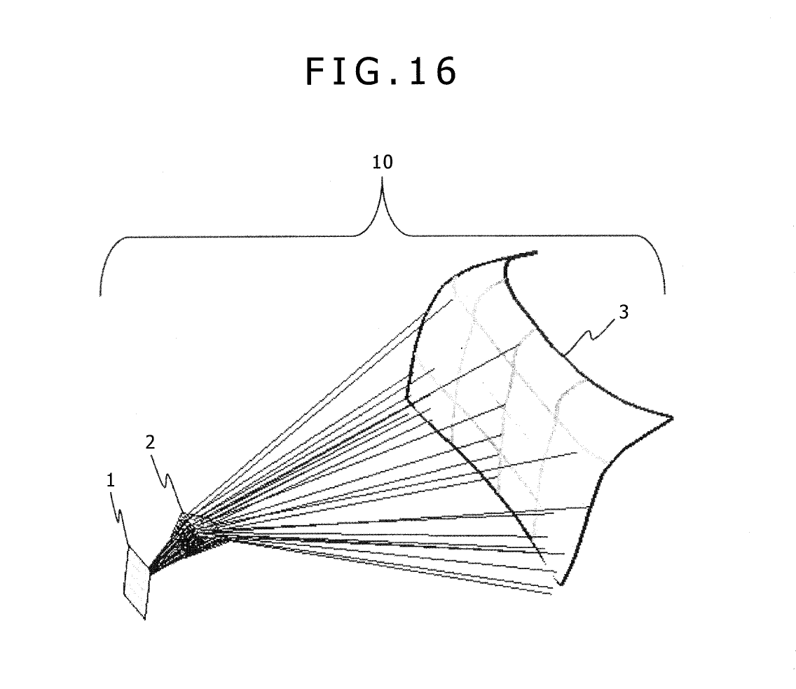

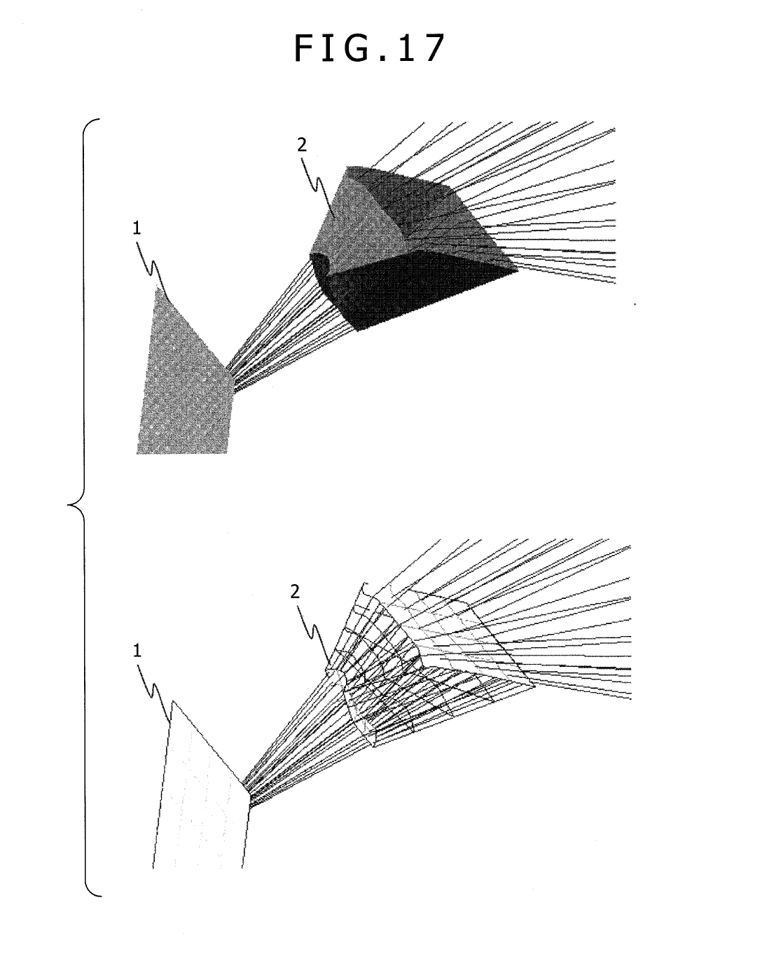

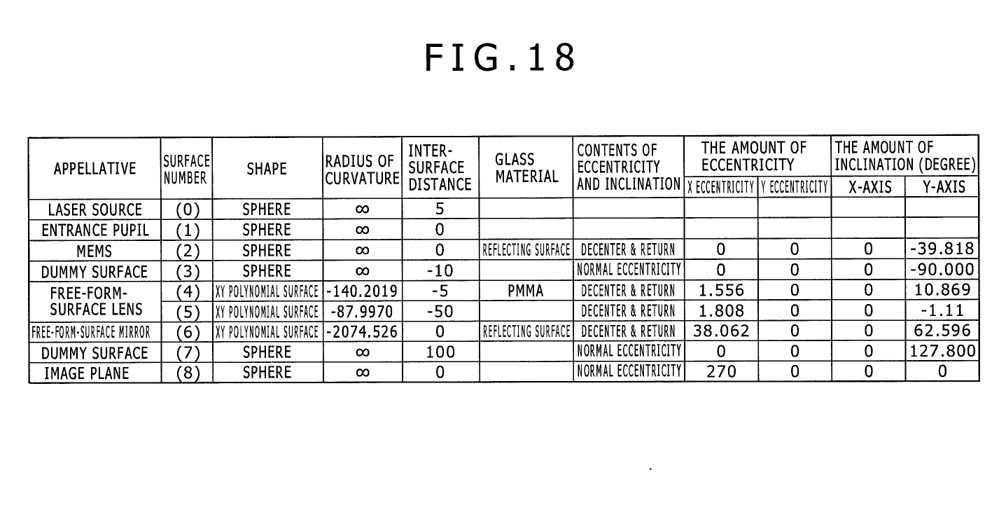

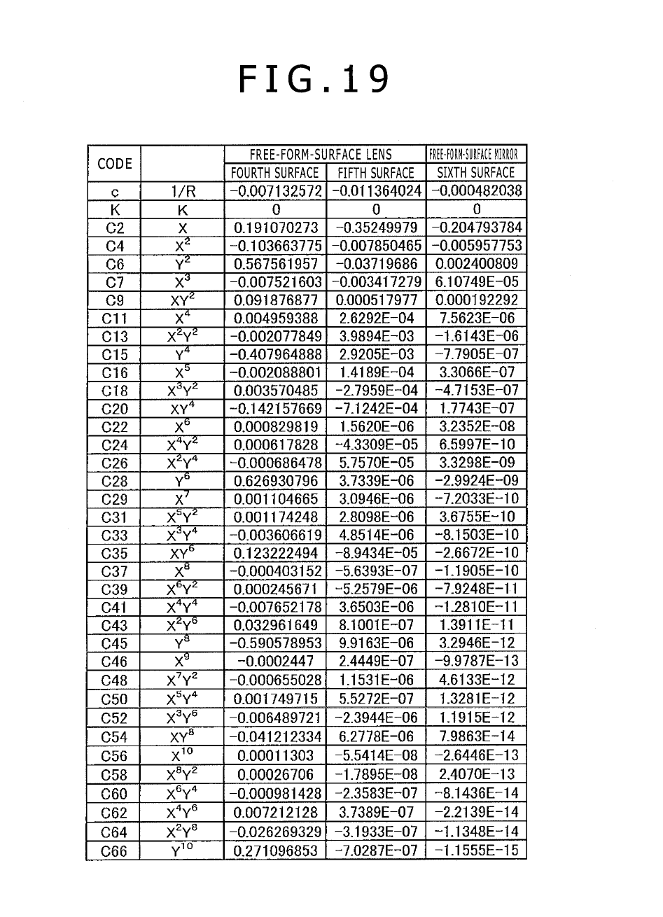

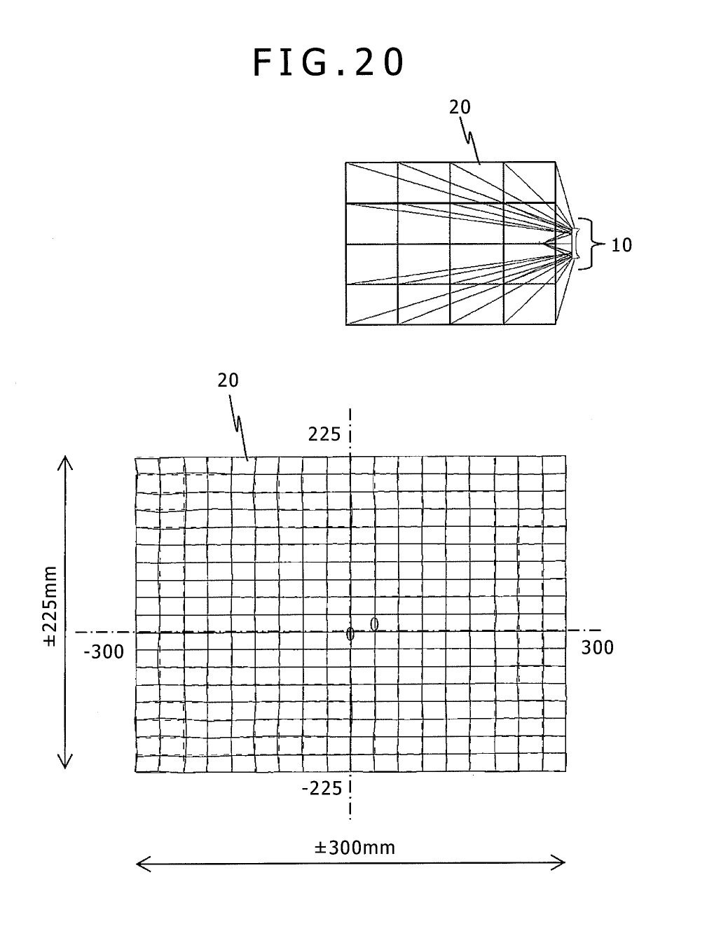

Subsequently, a second embodiment will be described with reference to FIGS. 15 to 20. FIG. 15 is one optical beam diagram of the second embodiment, FIG. 16 is another optical beam diagram of the second embodiment, FIG. 17 is a detailed diagram of a free-form-surface lens in the second embodiment, FIG. 18 is a diagram illustrating lens data in the second embodiment, FIG. 19 is a diagram illustrating specific values of a free curved surface coefficient in the second embodiment, and FIG. 20 is a distortion performance diagram of the second embodiment.

A difference from the first embodiment resides in that the number of free-form-surface lenses 2 is one. However, since X=600 mm and L=100 mm are satisfied even in the second embodiment, L/X which is a very small value, that is, 0.17 can be realized.

### Third Embodiment

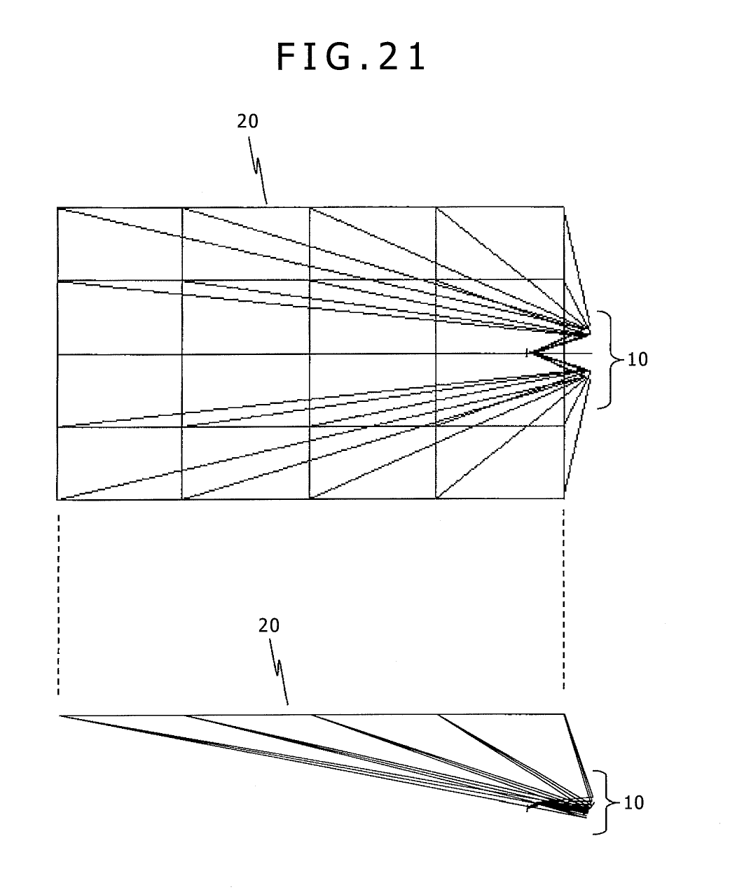

Subsequently, a third embodiment will be described with reference to FIGS. 21 to 26.

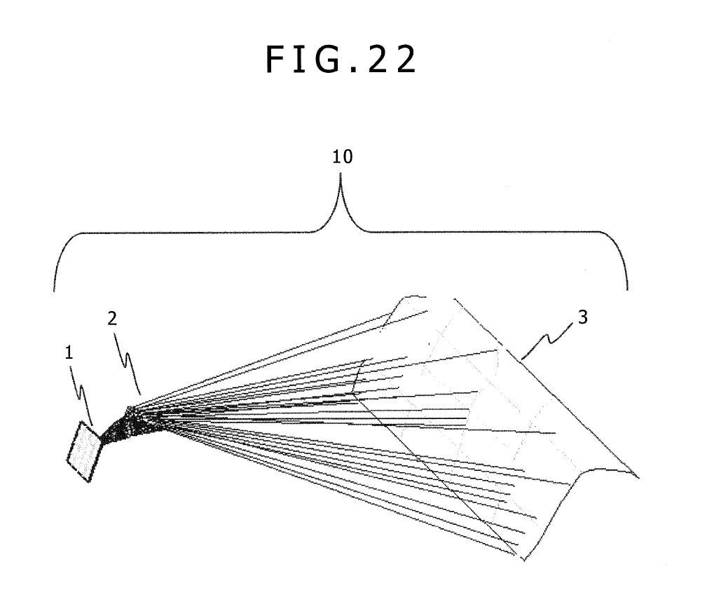

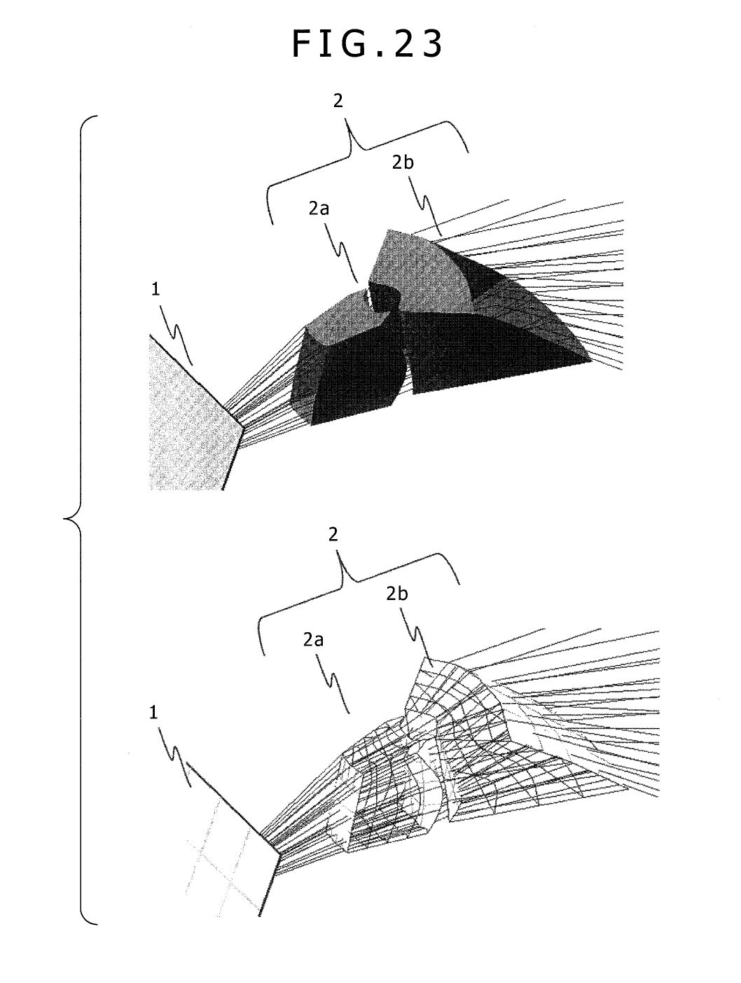

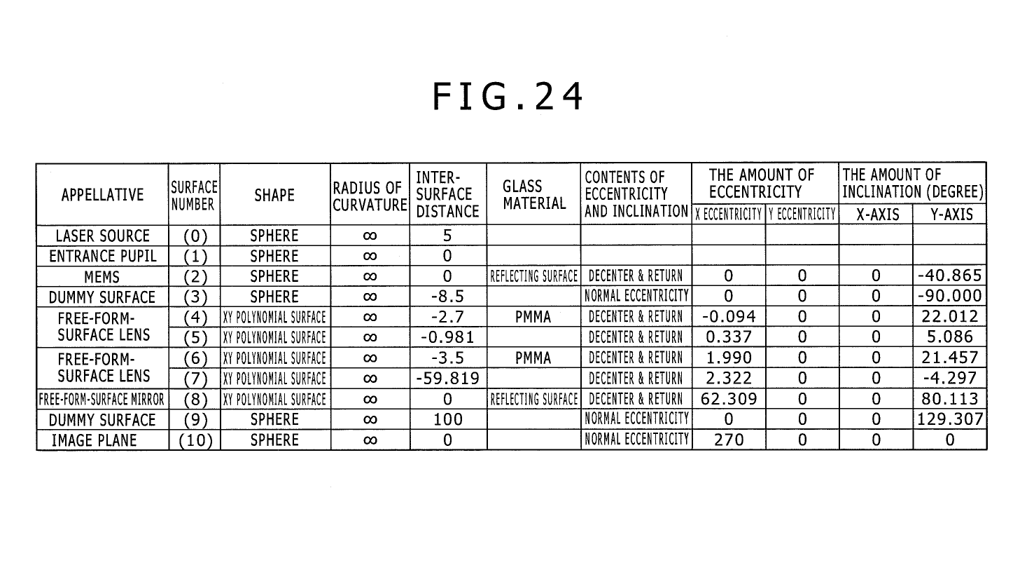

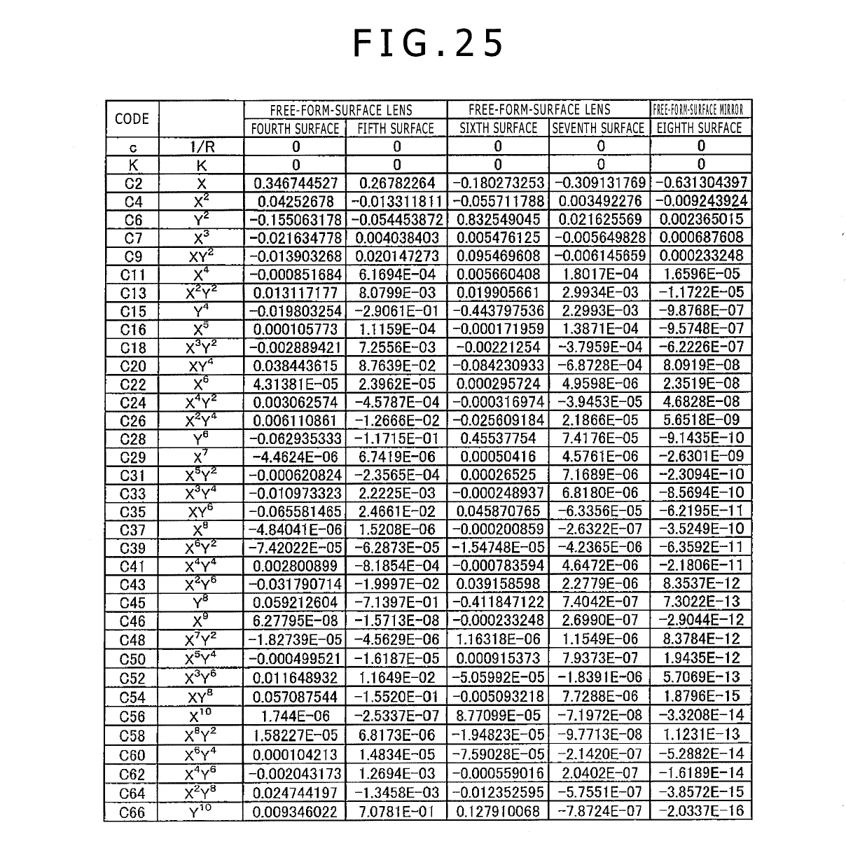

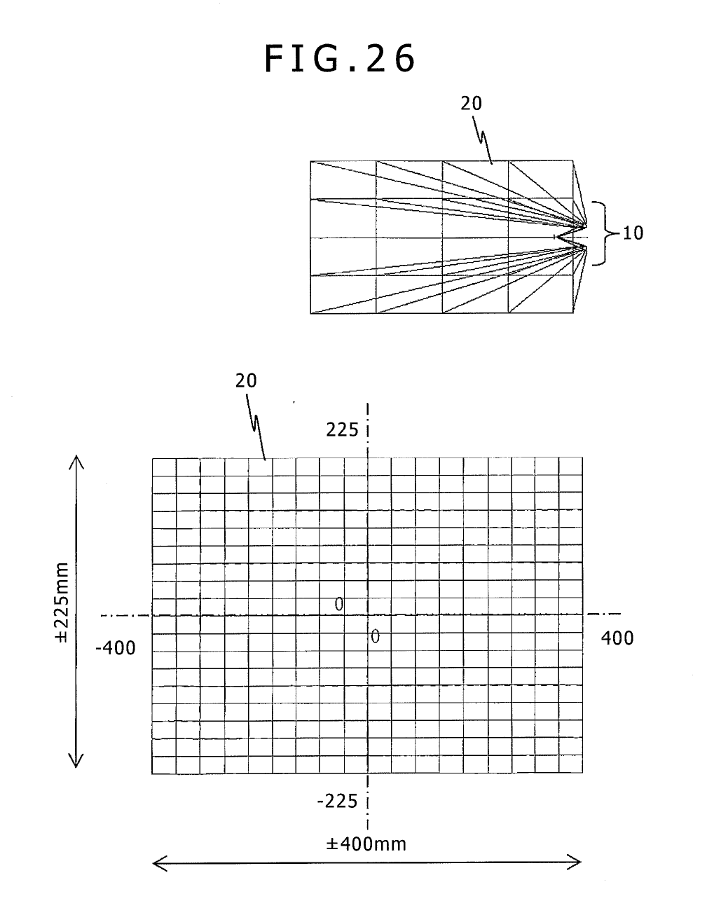

FIG. 21 is one optical beam diagram of the third embodiment, FIG. 22 is another optical beam diagram of the third embodiment, FIG. 23 is a detailed diagram of a free-form-surface lens in the third embodiment, FIG. 24 is a diagram illustrating lens data in the third embodiment, FIG. 25 is a diagram illustrating specific values of a free curved surface coefficient in the third embodiment, and FIG. 26 is a distortion performance diagram of the third embodiment.

Differences from the first embodiment reside in that an image plane is set to 16:9 in conformity to an original wide screen, and the rotation angle (resonance rotation ±5.3 degrees horizontally and ±2.9 degrees vertically) is set to a two-dimensional range of 800×450 mm. The linearity which is the distortion performance in FIG. 26 is improved more than the linearity which is the distortion performance of the first embodiment illustrated in FIG. 9. In the optical scanning unit 1 originally developed to scan the image plane of 16:9, scanning the image place of 16:9 is excellent as combination. It is needless to say that the scanning mirror developed at 16:9 can be also applied to the image plane of 4:3.

In the third embodiment, since X=800 mm and L=100 mm are satisfied, L/X which is a very small value, that is, 0.135 can be realized.

### LIST OF REFERENCE SIGNS

1 . . . optical scanning unit 1, 2 . . . free-form-surface lens, 3 . . . free-form-surface mirror, 4 . . . light source, 10 . . . image display device, 20 . . . image plane, 30 . . . structure, 1a . . . mirror, 1b . . . first torsion spring, 1c . . . retention member, 1d . . . second torsion spring, and 1e . . . holding member.

1. An image display device comprising:
an optical scanning unit that scans a light emitted from a light source in a first direction and a second direction of an image plane due to a rotational movement of reciprocation of a reflecting surface of the light; and
an optical system enlarges a scanning angle of the scanned light,
wherein the optical system has a free-form-surface lens on an optical scanning unit side, and has a free-form-surface mirror on an image plane side.

2. The image display device according to claim 1,
wherein a length in the first direction is longer than a length in the second direction, and
wherein the free-form-surface mirror is arranged so that the first direction is substantially parallel to a first plane defined by an incident optical beam and a reflected light in the free-form-surface mirror when the optical scanning unit remains static in the center of the scanning area.

3. The image display device according to claim 1 or claim 2,
wherein the optical scanning unit has one reflecting surface having two scanning directions.

4. The image display device according to claim 1 or claim 2,
wherein the optical scanning unit has two reflecting surfaces each having one reflecting surface.

5. The image display device according to any one of claims 1 to 4,
wherein a larger one of a deflection angle of the reflecting angle in two scanning directions corresponds to the first direction, and a smaller one of the deflection angle of the reflecting angle in the two scanning directions corresponds to the first direction corresponds to the second direction.

6. The image display device according to any one of claims 1 to 5,
wherein an optical path length by which an optical beam longer in a distance from the reflection position on the free-form-surface mirror to a scanning position on the image plane passes through the free-form-surface lens in the first plane is larger than an optical path length by which an optical beam shorter in the distance from the reflection position on the free-form-surface mirror to the scanning position on the image plane passes through the free-form-surface lens.

7. The image display device according to any one of claims 1 to 6,
wherein the free-form-surface lens on the image plane in the second direction has a negative refractive power.

8. The image display device according to any one of claims 1 to 6,
wherein a peripheral portion of the free-form-surface mirror on the image plane in the second direction has a negative refractive power.

9. The image display device according to any one of claims 1 to 8,
wherein when it is assumed that a length in the first direction is X, and a projector distance that is a vertical length which lowers from a reference position defining an arrangement position of the free-form-surface mirror on lens data toward the image plane is L, L/X is 1 or lower.

10. The image display device according to any one of claims 1 to 8,
wherein when it is assumed that a length in the first direction is X, and a projector distance that is a vertical length which lowers from a reference position defining an arrangement position of the free-form-surface mirror on lens data toward the image plane is L, L/X is 0.2 or lower.
